(19) United States
(12) Patent Application Publication
(10) Pub. No.: US 2010/0134400 A1
(43) Pub. Date: Jun. 3, 2010

(54) LIQUID CRYSTAL DISPLAY DEVICE WITH REDUCED POWER CONSUMPTION AND DRIVING METHOD THEREOF

(75) Inventors: Cheng-Lung Chiang, Tainan (TW); Ming-Cheng Chiu, Tainan (TW)

Correspondence Address: BAKER & MCKENZIE LLP;PATENT DEPARTMENT, 2001 ROSS AVENUE, SUITE 2300, DALLAS, TX, 75201, US

(73) Assignee: HIMAX TECHNOLOGIES LIMITED, Tainan (TW)

(21) Appl. No.: 12/325,891

(22) Filed: Dec. 1, 2008

(51) Int. Cl. G09G 3/36

(52) U.S. Cl. 345/98

(57) ABSTRACT

A liquid crystal display (LCD) device with reduced power consumption is provided with a plurality of data lines, a plurality of gate lines, and at least one multiplexer. Each multiplexer can comprise a plurality of switches respectively connected to the corresponding data lines and controlled by a plurality of clock signals and configured to receive an image signal, and selectively output the image signal to one of the data lines via the switches. During a driving period, one of the gate lines can be asserted, and the switches can be turned on simultaneously, then only the first one of the switches remains turned on to transmit the image signal to the corresponding data line, and then the first one of the switches are turned off and the other switches are sequentially turned on one at a time to transmit the image signal to the corresponding data lines.

### BACKGROUND

1. Technical Field

The embodiments described herein relate to a display device and more particularly to a low temperature polysilicon (LTPS) display device with an enhanced timing control to reduce power consumption.

2. Description of the Related Art

Recently, a variety of electronic display devices and products have undergone significant changes due to the rapid development of semiconductor devices and user interfaces of the devices. Liquid crystal display (LCD) devices, for example, thin film transistor (TFT) LCD devices, have quickly become the mainstream of display devices. In general, the conventional thin film transistor (TFT) may be classified as either an a-Si (Amorphous Silicon) thin film transistor (TFT) or a polysilicon thin film transistor (TFT). A-Si and LTPS are both technologies for integrating TFT onto a glass substrate. The technology of low temperature polysilicon (LTPS) is different from the technology of conventional a-Si. The most obvious differences being the electrical characteristics and complexity of processing. In low temperature polysilicon (LTPS) technology, electron mobility can be enhanced to more than 200 cm²/V-sec. Therefore, the size of the thin film transistor (TFT) can be minimized, the aperture ratio of the display can be enhanced, and the power consumption can be reduced.

In general, for amorphous silicon TFT display devices, each data channel drives only one pixel. In contrast, for LTPS TFT display devices, they are provided with multiplexers for data drivers, so that one data channel can drive more than one pixel at a time. However, the loading for LTPS TFT display devices is mainly in the multiplexers and panel pixels following the multiplexers. The timing control of the multiplexers will play a crucial rule in any improvements made to the power consumption of the LTPS TFT display device. An adaptive LTPS timing control for enhanced power saving efficiency is therefore needed.

### SUMMARY

A display device and a driving method thereof with improved multiplexer timing control and hence reduced power consumption, are described herein.

According to one aspect, a liquid crystal display (LCD) device can comprise a plurality of data lines, a plurality of gate lines, and at least one multiplexer. Each of the multiplexer can comprise a plurality of switches respectively connected to the corresponding data lines and controlled by a plurality of clock signals, receive an image signal, and selectively output the image signal to one of the data lines via the switches. During a driving period, one of the gate lines can be asserted, and the switches can be turned on simultaneously, while only the first one of the switches remains turned on to transmit the image signal to the corresponding data line, and then the first one of the switches can be turned off and the other switches can be sequentially turned on one at a time to transmit the image signal to the corresponding data lines.

According to another aspect, a driving method of a liquid crystal display (LCD) device is disclosed. The LCD device can include data lines, gate lines, and a multiplexer. The multiplexer can have switches respectively connected to the corresponding data lines. The multiplexer can receive an image signal and selectively output the image signal to one of the data lines via the switches. The driving method can comprise the steps: asserting one of the gate lines, simultaneously turning on the switches, maintaining only the first one of the switches turned on to transmit the image signal to the corresponding data line, and then turning off the first one of the switches and sequentially turning on the other switches one at a time to transmit the image signal to the corresponding data lines.

These and other features, aspects, and embodiments are described below in the section entitled “Detailed Description.”

### BRIEF DESCRIPTION OF THE DRAWINGS

Features, aspects, and embodiments are described in conjunction with the attached drawings, in which:

FIG. 1 is a block diagram of a display device in accordance with one embodiment; and

FIG. 2 is a timing diagram showing waveforms of typical signals of the display device in FIG. 1 in accordance with one embodiment.

### DETAILED DESCRIPTION

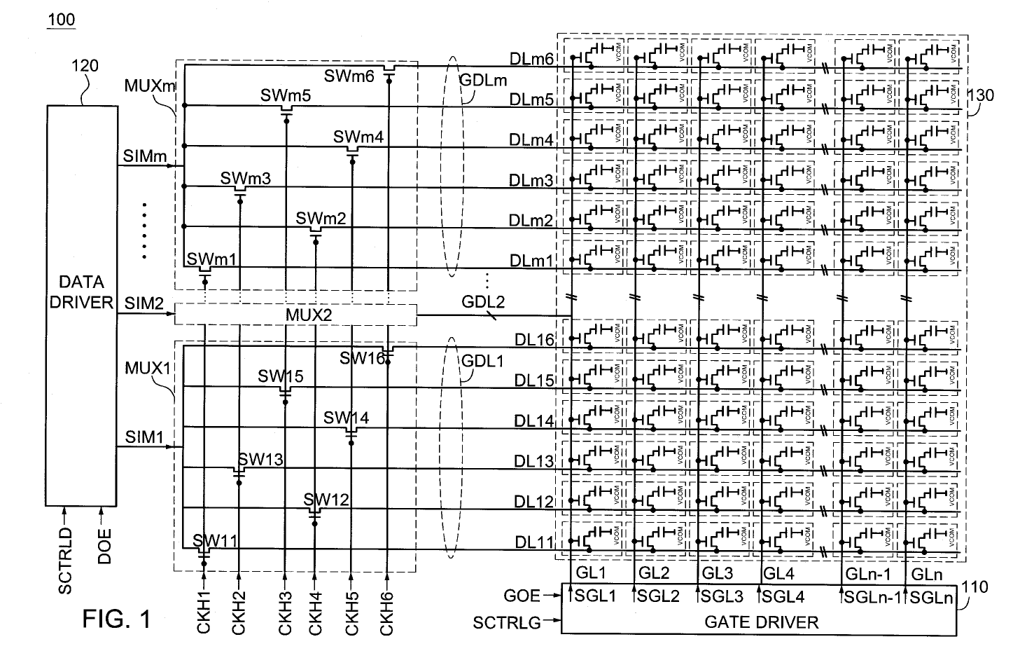

FIG. 1 is a block diagram of a display device in accordance with an embodiment. As shown, the display device 100, for example, a low temperature polysilicon (LTPS) LCD device, can comprise a gate driver 110, a data driver 120, a plurality of multiplexers MUX1, MUX2, . . . MUXm, and an LCD panel 130 having a plurality of pixel cells arranged at intersections between a plurality of gate lines GL1, GL2, . . . , GLn and a plurality of data line groups GDL1, GDL2, . . . , GDLm (where m and n are non-zero integers). The LCD panel 130, for example, can be a low temperature poly-silicon (LTPS) panel. Each of the pixel cells in the LCD panel 130 can comprise a thin film transistor (TFT) and a capacitor coupled to a reference voltage V_{COM}. The data line group GDLi (where i is a non-zero integer between 1 and m) can comprise a plurality of data lines DLi1, DLi2, . . . , DLip (where p is a non-zero integer and p=6 in the exemplary embodiment). It should be noted, however, that the data line groups GDL1-GDLm can comprise different numbers of data lines in other embodiments.

The gate driver 110, connected to the gate lines GL1, GL2, . . . , GLn, can be configured to make an on/off control of the TFT's arranged on the LCD panel 130 to allow image signals from the data driver 120 to be applied to each pixel. The gate driver 110, in response to a gate control signal ‘SCTRLG’ from a timing controller (not shown), can sequentially apply gate driving signals ‘SGL1’, ‘SGL2’, . . . , ‘SGLn’ respectively to the gate lines GL1, GL2, . . . , GLn to turn on the TFTs in the pixels connected to the corresponding gate lines. Additionally, the gate driver 110 can receive a gate output enable signal ‘GOE’ from the timing controller. The gate output enable signal ‘GOE’ can be a signal for controlling the output of the gate driver 110, that is, controlling output of the gate driving signals ‘SGL1’, ‘SGL2’, . . . , ‘SGLn’ from the gate driver 110. Specifically, when the gate output enable signal ‘GOE’ assumes a first state (e.g., high state), the gate driver 110 can be enabled to provide the gate driving signals ‘SGL1’, ‘SGL2’, . . . , ‘SGLn’, so the gate lines GL1 to GLn are respectively driven to the levels of the gate driving signals ‘SGL1’, ‘SGL2’, . . . , ‘SGLn’; and when the gate output enable signal ‘GOE’ assumes a second state (e.g., low state), the gate driver 110 can terminate providing the gate driving signals ‘SGL1’, ‘SGL2’, . . . , ‘SGLn’ and can force the gate lines GL1 to GLn at low states.

The data driver 120 can be configured to supply image signals to the data line groups GDL1, GDL2, . . . , GDLm respectively through the multiplexers MUX1-MUXm. The data driver 120 can receive a data control signal ‘SCTRLD’ including video data from the timing controller, converts it to image signals ‘SIM1’, ‘SIM2’, . . . , ‘SIMm’, and supplies the image signals ‘SIM1’-‘SIMm’ respectively to the multiplexers MUX1-MUXm.

The multiplexer MUXj, for example, formed on the low temperature polysilicon panel 130, can comprise a plurality of switches SWj1, SWj2, . . . , SWjp. The switches SWj1, SWj2, . . . , SWjp can be respectively connected to the corresponding data lines DLj1, DLj2, . . . , DLjp and controlled by a plurality of clock signals ‘CKH1’, ‘CKH2’, . . . , ‘CKHp’ (where j is any integer between 1 and m). The clock signals ‘CKH1’, ‘CKH2’, . . . , ‘CKHp’ can be signals for controlling the transmission of the image signal ‘SIMj’ through the switches SWj1, SWj2, . . . , SWjp to the data lines DLj1, DLj2, . . . , DLjp. Specifically, when the clock signal ‘CKHk’ (1≦k≦p) is at a first state (e.g., high state), the switch SWjk is turned on, and the MUXj transmits the image signal ‘SIMj’ to the data line DLjk; and conversely, when the clock signal ‘CKHk’ is at a second state (e.g., low state), the switch SWjk is turned off, and the MUXj stops transmitting the image signal ‘SIMj’ to the data line DLjk. Because the TFT of each pixel connected to the gate line GLj is turned on when a high level of corresponding gate driving signal ‘SGLj’ can be applied to the gate line GLj, the clock signals ‘CKH1’-‘CKHp’ can be sequentially set high during the high state of the gate driving signal ‘SGLj’ to allow the image signal ‘SIMj’ to be sequentially provided to the data lines DLj1, DLi2, . . . , DLjp.

Additionally, the data driver 120 can receive a data output enable signal ‘DOE’ from the timing controller. The data output enable signal ‘DOE’ is a prompt for when to supply the pixel with data. In other words, the data output enable signal ‘DOE’ is a signal that can be used to control the output of data driver 120 by controlling the output of the image signals ‘SIM1’-‘SIMm’ from data driver 120. Specifically, when the data output enable signal ‘DOE’ assumes a first state (e.g., high state), the data driver 120 is enabled to output the image signals ‘SIM1’-‘SIMm’ so that the inputs of the multiplexers MUX1-MUXm are respectively pulled to the levels of the image signals ‘SIM1’-‘SIMm’; and when the data output enable signal ‘DOE’ assumes a second state (e.g., low state), the data driver 120 terminates outputting the image signals ‘SIM1’-‘SIMm’.

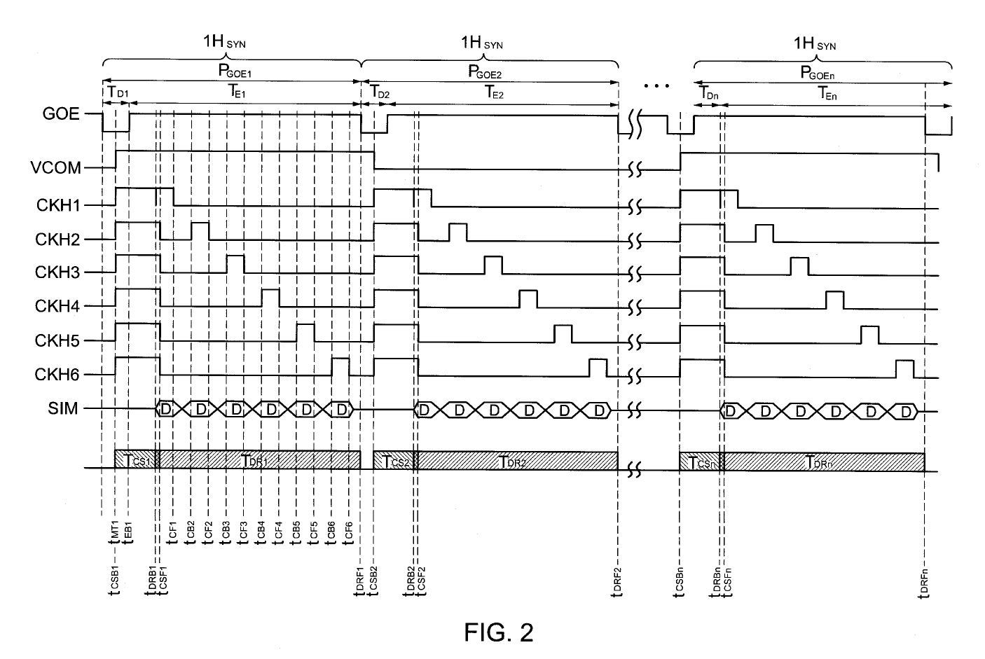

FIG. 2 is a timing diagram showing waveforms of typical signals of the display device 100 in FIG. 1 in accordance with an embodiment, wherein the LCD panel 130 can be driven by a line inversion (also referred to as gate inversion or row inversion) method. Referring to FIG. 2, the gate output enable signal ‘GOE’ has period P_{GOE}s each equal to one horizontal synchronizing period H_{SYN}. Each period P_{GOEi} can consist of an enable interval T_{Ei} and a disable interval T_{Di} (1≦i≦m). During the enable intervals T_{E1}, T_{E2}, . . . , T_{En}, the gate driving signals ‘SGL1’-‘SGLn’ can be sequentially turned on high to turn on the TFTs connected to the corresponding gate lines GL1-GLn; and during the disable intervals T_{D1}-T_{Dn}, all the gate driving signals ‘SGL1’-‘SGLn’ can be pulled low, turning off the TFTs.

Because the LCD panel 130 is driven by a line inversion method, the polarity of the reference voltage V_{COM} can be toggled every one horizontal synchronizing period H_{SYN}. As shown, for example, the polarity of the voltage V_{COM} can be changed at time t_{MT1} during the first disable period T_{D1} of the gate output enable signal ‘GOE’.

At time t_{CSB1} during the disable interval T_{D1}, a starting point of a charge-sharing period T_{CS1}, all the clock signals ‘CKH1’-‘CKHp’ can be simultaneously set to a high level, thereby electrically connecting the data lines DL11-DL1p, wherein the toggling time t_{MT1} is preferably set equal to the starting time t_{CS1}. At the same time, the data output enable signal ‘DOE’ can be set to a low level, so the data driver 120 does not provide the image signals. As a result, the data lines DL11-DL16 can mutually share remaining charges previously (that is, before t_{CSB1}) stored therein and reach an average level of the previous voltages of the data lines DL11-DL16.

Afterwards, at time t_{EB1}, the gate output enable signal ‘GOE’ enters the first enable interval T_{E1}, and then the gate driver 110 starts to assert the gate line GL1 to high.

Afterwards, at time t_{DB1}, a starting point of a driving period T_{DR1}, the data output enable signal ‘DOE’ transitions from low to high, enabling the image signal ‘SIM1’ to be supplied to the multiplexer MUX1. Meanwhile, the clock signals ‘CKH1’-‘CKH6’ can still all be maintained at high states, so that the charge sharing continues. As a result, the data lines DL11-DL16 connected to the multiplexer MUX1 can be driven towards the level of the image signal ‘SIM1’.

Shortly afterwards, at time t_{CSF1}, an ending point of the charge-sharing period T_{CS1}, all the clock signals except the first one, i.e. ‘CKH2’-‘CKH6’, can simultaneously transition from high to low, stopping the transmission of the image signal ‘SIM1’ from the data driver through the multiplexer MUX1 to the data lines DL12-DL16, which terminates the charge sharing.

At the same time, the data output enable signal ‘DOE’ can be maintained at the high state, so the image signal ‘SIM1’ can be output. As a result, the image signal ‘SIM1’ can be transmitted through the first switch SWj1 (that is turned on by the high level setting of first clock signal ‘CKH1’) to the first data line DL11 until time t_{CB1} (when the first clock signal ‘CKH1’ is turned to low).

Afterwards, at time t_{CB2}, the second clock signal ‘CKH2’ can be asserted to high and maintained until time t_{CF2} when it transitions to low again. During the interval between time t_{CB2} and t_{CF2}, the image signal ‘SIM1’ can be transmitted only to the second data line DL12. Afterwards, during time intervals t_{CB3}-t_{CF3}, t_{CB4}-t_{CF4}, . . . , t_{CB6}-t_{CF6}, the clock signals ‘CKH3’, ‘CKH4’, . . . , ‘CKH6’ can be sequentially turned high such that the image signal SIM1 can be transmitted sequentially to the data line DL13, DL14, . . . , DL16. As a result, one frame line corresponding to the first gate line GL1 is displayed.

Similar processes are realized during the enable intervals T_{E2}-T_{En}, during which the gate lines GL2-GLn can be driven high respectively and are thus omitted here for brevity.

One important feature of the embodiment is that the charge-sharing period T_{CSi} and the driving period T_{DRi} can be merged together. In the embodiment, the charge-sharing period T_{CSi} and the driving period T_{DRi} can be overlapped between the starting time t_{DRBi} of the driving period T_{DRi} and the ending time t_{CSFi} of the charge-sharing period T_{CSi}. The times t_{DRBi} and t_{CSFi} can be set close to each other to prevent the data lines DLi2-DLip from being driven too much by the image signal ‘SIMi’ in the charge sharing period T_{CSi}. In other embodiments, the times t_{DRBi} and t_{CSFi} can be set at the same point.

It is noted that in the embodiment, the reference voltage V_{COM} can be toggled every horizontal synchronizing period H_{SYN} to realize line inversion (t_{MTi}=t_{CSBi}). However, the invention is not limited thereto. For example, in another embodiment with fixed polarity of the reference voltage V_{COM}, the line inversion can be realized by toggling the image signals ‘SIM1’-‘SIMm’ instead. In such an embodiment, the duration when all the clock signals are turned high, namely the charge-sharing period T_{CSi}, can still be started simultaneously with the toggling time of the image signals ‘SIM1’-‘SIMm’ every horizontal synchronizing period H_{SYN}.

It is also noted that in the embodiment using the line inversion method, the reference voltage V_{COM} can be toggled every horizontal synchronizing period H_{SYN}. However, the embodiments described herein are not limited to just the line inversion method, and can be applied to the frame inversion method, the data inversion (also referred to as column inversion or source inversion) method, the dot inversion method, and other comparabale driving methods. In the other driving methods, the polarity of the reference voltage V_{COM} is not necessarily switched every horizontal synchronizing period H_{SYN}. In these embodiment, the charge-sharing period T_{CSi} , or the duration when all the clock signals are turned high, can still be started during the disable interval T_{Di} of the gate output enable signal GOE, that is, before any of the gate lines is driven high.

For a display device without implementations of multiplexers, an image signal ‘SIMi’ has to be continuously provided to a corresponding data line DLi during the enable interval of a horizontal synchronizing period. However, in a display device with the multiplexers MUX1-MUXp, each image signal can be transmitted sequentially to the data lines DLi1-DLip during the enable interval of a horizontal synchronizing period. In other words, each data line is provided with the image signal ‘SIMi’ only for a part of the horizontal synchronizing period, or 1/p times the driving period T_{DRi} in FIG. 2 (1≦i≦m ), which is much shorter than that the time without the multiplexers. The power consumption of the display device can therefore be reduced.

Additionally, with all of the clock signals simultaneously turned high in the charge-sharing period, the power consumption can also be further reduced. That is, the level of each data line can be pulled to the average level of the previous voltages due to charge sharing before being pulled to the level of the image signal during the driving period. The voltage difference on each data line required to be driven during the driving period is thus lower than that without charge sharing, and the power consumption can be reduced.

Additionally, because the charge-sharing period and the driving period are merged rather than separated, that is, the charge-sharing period is extended to reach the driving period, the charge-sharing period is longer compared to that separate from the driving period. Consequently, the charge-recycling can be realized more completely and the power consumption can be further reduced. Also, due to the merging, the first clock signal can be continuously turned high from the charge-sharing period to the driving period, and the driving mechanism for the first clock signal can be simplified.

While certain embodiments have been described above, it will be understood that the embodiments described are by way of example only. Accordingly, the apparatus and methods described herein should not be limited based on the described embodiments. Rather, the apparatus and methods described herein should only be limited in light of the claims that follow when taken in conjunction with the above description and accompanying drawings. Therefore, the scope of the appended claims should be accorded the broadest interpretation so as to encompass various modifications and similar arrangements [as would be apparent to those skilled in the art].

What is claimed is:

1. A liquid crystal display (LCD) device, comprising:
a plurality of data lines;
a plurality of gate lines; and
at least one multiplexer, each comprising a plurality of switches respectively connected to the corresponding data lines and controlled by a plurality of clock signals, the at least one multiplexer configured to receive an image signal and selectively output the image signal to one of the data lines via the switches;
wherein during a driving period, one of the gate lines is asserted, and the switches are turned on simultaneously, then only the first one of the switches remains turned on to transmit the image signal to the corresponding data line, and then the first one of the switches are turned off and the other switches are sequentially turned on one at a time to transmit the image signal to the corresponding data lines.

2. The LCD device of claim 1, wherein the LCD device further comprises a plurality of pixel cells each comprising a capacitor coupled to a reference voltage, wherein during the driving period, the switches are turned on simultaneously when the reference voltage is toggled.

3. The LCD device of claim 1, wherein the LCD device is a low temperature polysilicon (LTPS) device.

4. The LCD device of claim 1, wherein the multiplexer is formed on a low temperature polysilicon panel.

5. A driving method of a liquid crystal display (LCD) device, the LCD device includes data lines, gate lines, and a multiplexer having switches respectively connected to the corresponding data lines, the multiplexer configured to receive an image signal, and selectively output the image signal to one of the data lines via the switches, the driving method comprising:
asserting one of the gate lines;
simultaneously turning on the switches;
maintaining only the first one of the switches turned on to transmit the image signal to the corresponding data line; and
turning off the first one of the switches and sequentially turning on the other switches one at a time to transmit the image signal to the corresponding data lines.

6. The driving method of claim 5, wherein the LCD device further includes a plurality of pixel cells each comprises a capacitor coupled to a reference voltage, and the driving method further comprises a step of toggling the reference voltage when the switches are turned on simultaneously.

7. The driving method of claim 5, wherein the LCD device is a low temperature polysilicon (LTPS) device.
